(19) United States
(12) Patent Application Publication
(10) Pub. No.: US 2006/0282176 A1
(43) Pub. Date: Dec. 14, 2006

(54) Supply control method and apparatus

(76) Inventors: Edward A. Burton, Hillsboro, OR (US); Anant Deval, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/151,817

(22) Filed: Jun. 13, 2005

(51) Int. Cl. G05B 11/01

(52) U.S. Cl. 700/22

(57) ABSTRACT

In some embodiments, a supply control system is provided that assesses degradation of a CPU core and increases a supply to the core based on the assessed degradation. Other embodiments may be disclosed herein.

### BACKGROUND

With many integrated circuit (IC) chips such as CPU (or microprocessor) chips, the operating frequency can be a limiter in the drive for enhancing operational performance. Unfortunately, as chips are used over time,, they can degrade resulting in a reduction of operating capability. For example, with complementary metal oxide semiconductor (CMOS) devices, operation over time under relatively stressful circumstances (e.g., high supply voltage, high frequency, high temperature) can lead to gate breakdown, which slows down the transistors. Accordingly, a frequency guardband (e.g., three to four percent safety margin reduction) may be imposed to reduce even further allowed operating frequencies in order to account for this degradation. Unfortunately, since chips may be valued based on rated frequencies, this can have an adverse commercial impact.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a CPU including a supply control system according to some embodiments of the invention.

FIG. 2 is a flow diagram showing a routine to perform supply control according to some embodiments of the system of FIG. 1.

FIG. 3 is a block diagram of a CPU including a supply control system according to some other embodiments of the invention.

FIG. 4 is a flow diagram showing a routine to perform supply control according to some embodiments of the system of FIG. 3.

FIG. 5 is a block diagram of a computer system with a CPU chip having multiple cores with supply control systems in accordance with some embodiments of the invention.

### DETAILED DESCRIPTION

With some embodiments described herein, instead of (or in addition to) guard-banding the frequency, supply voltage may be increased as a chip degrades over time. The amount of degradation may be assessed in various different ways. In some embodiments, it may be done by counting time spent in damaging states. In others, it may be done by measuring damage accrual, for example, in a proxy circuit. In these and other cases, the voltage may be increased at least enough to offset the slowdown resulting from the degradation.

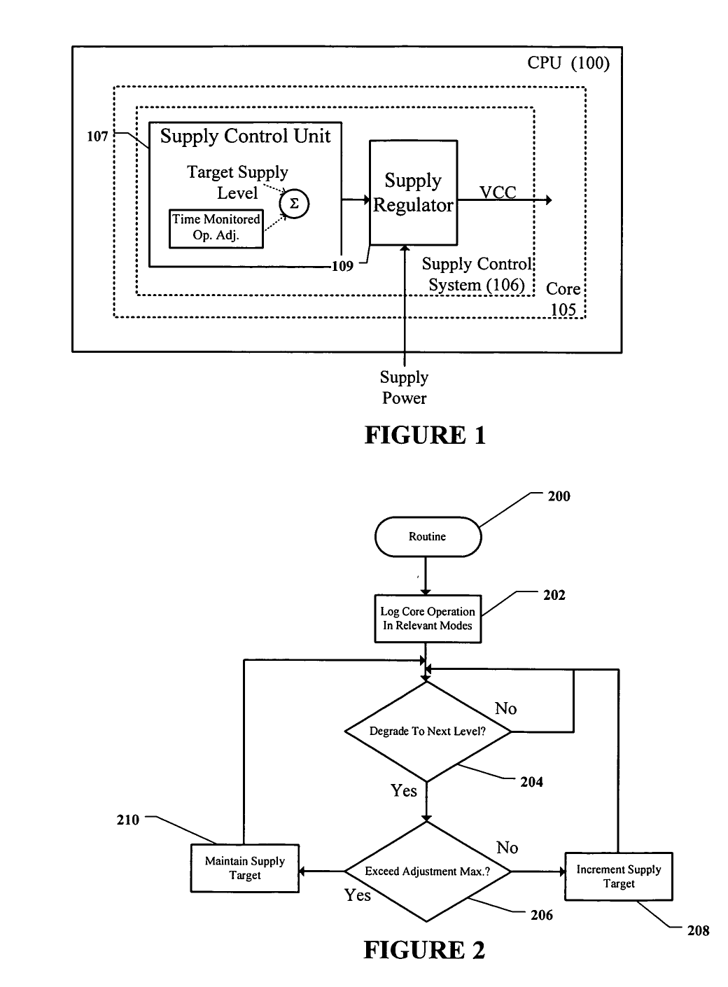

With reference to FIG. 1, a supply control system 106 in a core 105 of a CPU chip 100 is shown. The supply control system 106 comprises a supply control unit 107 coupled to a supply regulator 109 to provide it with a control signal to define the supply voltage (VCC) provided at its output. The VCC generated by the supply regulator 109 provides a voltage supply to the core 105. (Other voltage supplies may or may not be generated by supply regulator 109 or off of the generated VCC.) The supply regulator generates the VCC from supplied power (Supply Power), which may be supplied externally from the CPU chip 100. In some embodiments, the supply regulator 109 has sufficient resolution to be able to increment the VCC by as little as 1 mV.

The supply control unit 107 determines a value for VCC based on various criteria and in response to input signals (e.g., from the operating system, BIOS, etc.) depending on operating and/or other factors. For example, so-called “SpeedStep” (or “Geyserville”) power management schemes may be employed to operate a chip (or core of a chip) in different modes to conserve power when high performance is not required. Stated another way, when high performance is needed, the supply voltage VCC, along with the operating frequency, may be set to maximum allowed levels. In some embodiments, the supply control unit 107 determines the VCC value off of a baseline “target” level, adjusted for time-monitored degradation through the life cycle of the chip.

The target level is a baseline value that may be used by the supply control unit 107 to determine an appropriate level in view of received control signals, operating mode, etc. It may be set for a given type of chip, or it may be established for each manufactured chip or chips in a lot. The supply control unit monitors (or tracks) the operating conditions (either directly or indirectly) of a core or chip to log the amount of estimated degradation over time. Based on the amount of assessed degradation, the control unit 107 calculates an appropriate offset to be added to the target and uses this updated target as the new target VCC for controlling the supply regulator 109.

With reference to FIG. 2, a routine 200 that may be implemented in the supply control unit 107 is shown. At 202, the core (or at least relevant portions of a core) is monitored to log the amount of time it is operated in various relevant modes (e.g., particularly stressful—high performance, high temperature—operating modes). (All modes or just particularly degrading modes may be logged.)

At 204, it determines whether the amount of core degradation has moved up a level. A degradation product (or equivalent) may be used to quantify the amount of incurred degradation. For example, the time the core spends operating in a given mode could be multiplied by a coefficient whose value is proportional to the intensity of degradation for that mode. Different degradation thresholds could be established to define different degradation levels, with each being associated with a given adjusted VCC target value. As the degradation proceeds from one level to the next, the target VCC would be appropriately incremented.

If a degradation transition did not occur, then the routine loops back to 202 and cycles through step 204 until another transition occurs. On the other hand, if enough degradation occurred to constitute a transition to the next level, then at 206, the routine confirms whether or not the target VCC would be incremented above an acceptable limit (i.e., in this embodiment, a limit is placed on the amount that the VCC can be incremented over the life of a chip). If the target VCC has not yet exceeded the predefined limit, then at 208 the supply target is incremented, and the routine loops back to 204 to wait for the next transition. Otherwise, it maintains the supply target and loops back to 204 to monitor for another transition.

In some CMOS embodiments, an overall range of about 30 mV is used for adjusting the target VCC over the life of a chip (or core in a chip). with the use of a linear compensation scheme, for example, the chip's life-cycle of degradation may be divided into 30 separate windows with each window corresponding to an increment of 1 mV to be added to the target supply voltage when the amount of degradation transitions to the next level.

(It should be appreciated that the supply control unit 107 represents a functional block that may be implemented with a task-specific circuit or combination of circuits or with a general purpose circuit, e.g., micro-controller, which may be used for other tasks as well. It may be separate from the supply regulator 109, or it may be integrated with it to generate the supply voltage.)

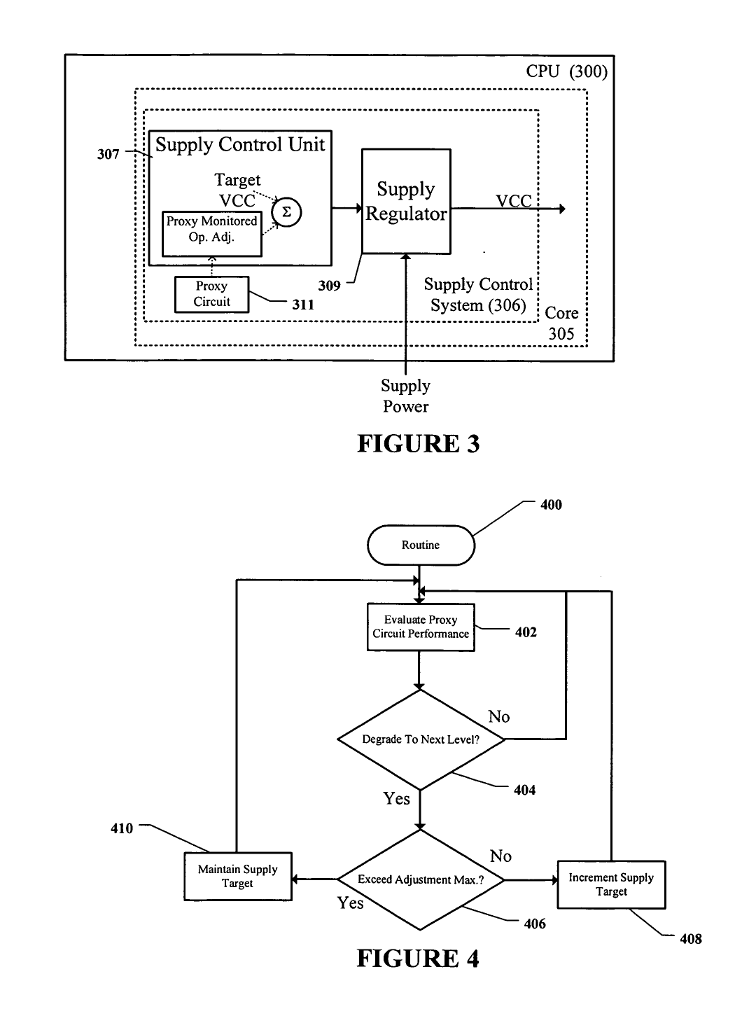

With reference to FIG. 3, a supply control system 306 in a core 305 of a CPU 300 according to some other embodiments of the invention is shown. The supply control system 306 comprises a supply control unit 307 coupled to a supply regulator 309 to provide it with a control signal to define the supply voltage (VCC) provided at its output. It also comprises a proxy circuit 311 coupled to the supply control unit 307 for assessing degradation incurred by the core. The supply voltage (VCC) provides a voltage supply to the core 305. (Other voltage supplies may or may not be generated by supply regulator 309 or off of the generated supply voltage VCC.) The supply regulator 309 generates the VCC from supplied power (Supply Power), which may be supplied externally from the CPU chip 300. In some embodiments, the supply regulator is capable of incrementing the VCC by as little as 1 mV.

The supply control unit 307 determines a value for VCC based on various criteria and in response to input signals depending on operating and/or other factors, as discussed above. In some embodiments, the supply control unit 307 determines the VCC value off of a baseline “target” level, which is adjusted for proxy circuit monitored degradation over time.

The target level is a baseline value that may be used by the supply control unit 307 to determine an appropriate level in view of received control signals, operating mode, etc. It may be set for a given type of chip, or it may be separately established for each manufactured chip or chips in a lot. The supply control unit 307 is coupled to the proxy circuit 311 to monitor it and assess the amount of degradation incurred by the core. A proxy circuit is a circuit that is used to model a core (or at least relevant parts of it) to assess the amount of incurred degradation. Accordingly, it typically has degradation characteristics (e.g., transistor parameters, operating conditions) that are similar to those of at least relevant parts of a core to be monitored. In one embodiment, a ring oscillator circuit is used as the proxy circuit 311. It is supplied with a VCC that corresponds to the VCC supplied to the core. It's operational performance (e.g., output voltage, frequency) is monitored by the supply control unit 307 to assess the amount of degradation it incurs over time. It uses this amount as an estimate of the degradation incurred by the core. In some embodiments, it could comprise a pair or pairs of oscillators with one being stressed (subjected to operating VCC) and the other unstressed. The incremental change between the two oscillators could then be used to estimate the degradation.

With reference to FIG. 4, a routine 400 that may be performed by supply control unit 307 is illustrated. At 402, the performance (e.g., frequency response) of the proxy circuit 311 is evaluated to assess the amount of degradation it has incurred. It may measure a physical parameter(s) (e.g., frequency, voltage) and directly correlate it with a degradation amount, or it may take a plurality of readings and integrate or average them to acquire a more accurate degradation value.

At 404, the routine determines whether the amount of degradation has transitioned to a next level. If not, it loops back to 402 and proceeds as described. On the other hand, if it moved up to the next degradation level, at 406, it confirms whether or not the target VCC would be incremented above an acceptable limit (i.e., in this embodiment, a limit is placed on the amount that the VCC can be incremented over the life of a chip). If the target VCC has not yet exceeded the predefined limit, then at 408 the supply target is incremented, and the routine loops back to 402 and proceeds as described. Otherwise, it maintains the supply target at its present level and loops back to 402 and proceeds as described.

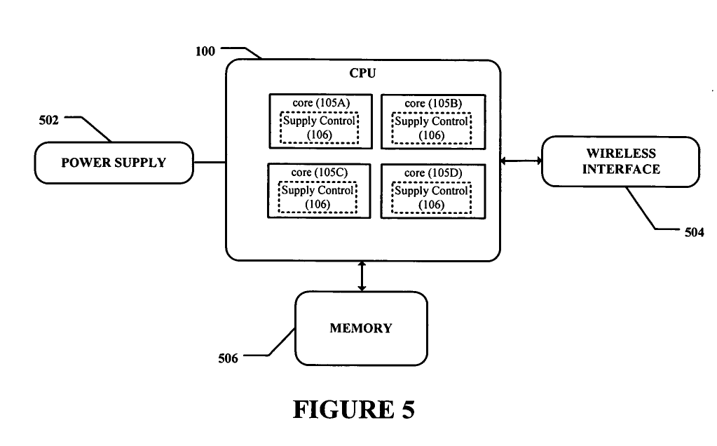

With reference to FIG. 5, one example of a computer system is shown. The depicted system generally comprises a CPU 500 that is coupled to a power supply 502, a wireless interface 504, and memory 506. CPU 500 is coupled to the power supply 502 (e.g., AC adaptor, battery) to receive from it power when in operation, and it is coupled to the wireless interface 504 and to the memory 506 with separate point-to-point links to communicate with the respective components. The wireless interface 504 may comprise circuitry and one or more antennas to communicatively link the CPU 500 to a network such as a local network or a wide area network. The CPU 500 includes a plurality of cores 105 each with at least one supply control system 106 (as discussed with reference to FIG. 1) with supply regulators 109 (not shown in this figure) coupled to the power supply 502.

It should be noted that the depicted system could be implemented in different forms. That is, it could be implemented in a single chip module, a circuit board, or a chassis having multiple circuit boards. Similarly, it could constitute one or more complete computers or alternatively, it could constitute a component useful within a computing system.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), application specific integrated circuits (ASICs), memory chips, network chips, and the like.

Moreover, it should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS. for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. A chip, comprising:
a circuit comprising a supply control unit coupled to a supply regulator, the supply control unit to define a supply level to be generated by the supply regulator based on an assessed amount of degradation to the circuit.

2. The chip of claim 1, in which the circuit comprises a CPU core.

3. The chip of claim 1, in which the supply level is a voltage supply level.

4. The chip of claim 1, in which the supply level to be defined is based on a target supply level.

5. The chip of claim 4, in which the target supply level is increased as the assessed degradation increases.

6. The chip of claim 5, in which the target supply level is incremented when a predefined degradation level is met.

7. The chip of claim 1, in which the supply control unit is implemented with one or more discrete logic circuits.

8. The chip of claim 1, in which the supply control unit is implemented with a microcontroller.

9. The chip of claim 1, in which the degradation is assessed from logging circuit operation in one or more degrading modes.

10. The chip of claim 1, comprising a proxy circuit coupled to the supply control unit, which is to assess the amount of degradation from evaluating the performance of the proxy circuit.

11. The chip of claim 10, in which the proxy circuit is implemented with one or more ring oscillator circuits.

12. A method, comprising:
assessing degradation of a CPU core; and
increasing a supply to the core based on the assessed degradation.

13. The method of claim 12, in which assessing degradation comprises assessing operating frequency capability of the core.

14. The method of claim 12, in which assessing degradation comprises logging the amount of time the core is operated in one or more degrading modes.

15. The method of claim 12, in which assessing degradation comprises measuring a performance of a proxy circuit in the core.

16. A computer system, comprising:
(a) a CPU comprising one or more cores, at least one of the cores comprising a supply control unit coupled to a supply regulator, the supply control unit to define a supply level to be generated by the supply regulator based on an assessed amount of degradation to the at least one of the cores.; and
(b) a wireless interface, including an antenna, coupled to the CPU to communicatively link the CPU to a network.

17. The system of claim 16, comprising a battery coupled to the supply regulator to provide it with power when the CPU is to be operated.

18. The chip of claim 16, in which the supply control unit is implemented with one or more discrete logic circuits.

19. The chip of claim 16, in which the supply control unit is implemented with a microcontroller.

20. The chip of claim 16, in which the degradation is assessed from logging core operation in one or more degrading modes.
